(19) United States
(12) Patent Application Publication
(10) Pub. No.: US 2008/0217515 A1
(43) Pub. Date: Sep. 11, 2008

(54) ILLUMINANCE DETECTION APPARATUS AND SENSOR MODULE

(75) Inventor: Tomoharu Fujii, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD, Nagano-shi (JP)

(21) Appl. No.: 12/044,540

(22) Filed: Mar. 7, 2008

(30) Foreign Application Priority Data
Mar. 8, 2007 (JP) 2007-058683

(51) Int. Cl. G01J 1/44

(52) U.S. Cl. 250/208.2

(57) ABSTRACT

A silicon substrate is used as a substrate body of a wiring substrate and also, plural light receiving elements for outputting a detection signal according to illuminance of light at the time of receiving light applied from the outside, an amplification circuit element for amplifying the detection signal outputted by the light receiving elements, a changeover switch element for performing switching as to whether or not the light receiving element is electrically connected to the amplification circuit element, and a resistor and a capacitor electrically connected to the amplification circuit element are disposed on the wiring substrate.

This application claims priority to Japanese Patent Application No. 2007-058683, filed Mar. 8, 2007, in the Japanese Patent Office. The priority application is incorporated by reference in its entirety.

### TECHNICAL FIELD

The present disclosure relates to an illuminance detection apparatus, and particularly to an illuminance detection apparatus comprising plural light receiving elements for outputting a detection signal according to illuminance of light applied from the outside, an amplification circuit element for amplifying the detection signal, an changeover switch element for performing switching as to whether or not the light receiving element is electrically connected to the amplification circuit element, and a passive element electrically connected to the amplification circuit element, and a sensor module.

### RELATED ART

An illuminance detection apparatus 200 as shown in FIG. 1 detects illuminance of light applied from the outside.

FIG. 1 is a sectional view of a related-art illuminance detection apparatus.

Referring to FIG. 1, the related-art illuminance detection apparatus 200 has a wiring substrate 201, an illuminance detection component 202, and a chip resistor 203 and a chip capacitor 204 which are passive elements.

The wiring substrate 201 disposes the illuminance detection component 202, the chip resistor 203 and the chip capacitor 204. The wiring substrate 201 has a substrate body 207, through vias 211 to 216, wirings 218, 219, 221 to 224, pads 225 to 229, 231 for external connection, and external connection terminals 233 to 238.

The substrate body 207 is formed in a plate shape. The through vias 211 to 216 are disposed so as to extend through the substrate body 207. The wirings 218, 219, 221 to 224 are disposed on an upper surface 207A of the substrate body 207. The wiring 218 is connected to the upper end of the through via 211 and the wiring 219 is connected to the upper end of the through via 212. The wiring 221 is connected to the upper end of the through via 213 and the wiring 222 is connected to the upper end of the through via 214. The wiring 223 is connected to the upper end of the through via 215 and the wiring 224 is connected to the upper end of the through via 216.

The pads 225 to 229, 231 for external connection are disposed on a lower surface 207B of the substrate body 207. The pad 225 for external connection is connected to the lower end of the through via 211 and the pad 226 for external connection is connected to the lower end of the through via 212. The pad 227 for external connection is connected to the lower end of the through via 213 and the pad 228 for external connection is connected to the lower end of the through via 214. The pad 229 for external connection is connected to the lower end of the through via 215 and the pad 231 for external connection is connected to the lower end of the through via 216.

The external connection terminal 233 is disposed on the pad 225 for external connection and the external connection terminal 234 is disposed on the pad 226 for external connection. The external connection terminal 235 is disposed on the pad 227 for external connection and the external connection terminal 236 is disposed on the pad 228 for external connection. The external connection terminal 237 is disposed on the pad 229 for external connection and the external connection terminal 238 is disposed on the pad 231 for external connection.

The illuminance detection component 202 has a ceramic substrate 241, plural light receiving elements 242, an amplification circuit element 244, a changeover switch element 245 and a translucent member 247.

The ceramic substrate 241 has a ceramic substrate body 251, through vias 252 to 255, pads 258 for light receiving element placement, wiring patterns 261 to 263, pads 265 to 268 for internal connection, and internal connection terminals 271 to 274.

The ceramic substrate body 251 has a recessed part 276 for accommodating the plural light receiving elements 242, the amplification circuit element 244 and the changeover switch element 245. The through vias 252 to 255 are disposed so as to extend through the ceramic substrate body 251 of the portion corresponding to the bottom of the recessed part 276.

The plural pads 258 for light receiving element placement are disposed at a predetermined spacing on a bottom surface 276A of the recessed part 276 of the portion corresponding to a formation position of the through via 252. The pads 258 for light receiving element placement are connected to the upper end of the through via 252.

The wiring pattern 261 is disposed on the bottom surface 276A of the recessed part 276 of the portion corresponding to a formation position of the through via 253. The wiring pattern 261 is connected to the upper end of the through via 253. The wiring pattern 262 is disposed on the bottom surface 276A of the recessed part 276 of the portion corresponding to a formation position of the through via 254. The wiring pattern 262 is connected to the upper end of the through via 254. The wiring pattern 263 is disposed on the bottom surface 276A of the recessed part 276 of the portion corresponding to a formation position of the through via 255. The wiring pattern 263 is connected to the upper end of the through via 255.

The pad 265 for internal connection is disposed on a lower surface 251A of the ceramic substrate body 251 of the portion corresponding to the formation position of the through via 252. The pad 265 for internal connection is connected to the lower end of the through via 252. The pad 266 for internal connection is disposed on the lower surface 251A of the ceramic substrate body 251 of the portion corresponding to the formation position of the through via 253. The pad 266 for internal connection is connected to the lower end of the through via 253.

The pad 267 for internal connection is disposed on the lower surface 251A of the ceramic substrate body 251 of the portion corresponding to the formation position of the through via 254. The pad 267 for internal connection is connected to the lower end of the through via 254. The pad 268 for internal connection is disposed on the lower surface 251A of the ceramic substrate body 251 of the portion corresponding to the formation position of the through via 255. The pad 268 for internal connection is connected to the lower end of the through via 255.

The internal connection terminal 271 is disposed on the pad 265 for internal connection and is electrically connected to the wiring 218 of the wiring substrate 201. The internal connection terminal 272 is disposed on the pad 266 for internal connection and is electrically connected to the wiring 219 of the wiring substrate 201. The internal connection terminal 273 is disposed on the pad 267 for internal connection and is electrically connected to the wiring 221 of the wiring substrate 201. The internal connection terminal 274 is disposed on the pad 268 for internal connection and is electrically connected to the wiring 222 of the wiring substrate 201.

In addition, the ceramic substrate 241 of the portion excluding the internal connection terminals 271 to 274 is formed by stacking a green sheet in which a conductor is formed and a green sheet in which a through part (corresponding to the recessed part 276) is formed and thereafter sintering the green sheets.

The light receiving elements 242 are arranged on the plural pads 258 for light receiving element placement. The light receiving element 242 has a light receiving part 281 for receiving light from the outside, a positive electrode 282 and a negative electrode 283. The positive electrode 282 is electrically connected to the wiring pattern 261 through a metal wire 285. The negative electrode 283 is electrically connected to the pads 258 for light receiving element placement.

The amplification circuit element 244 is disposed on the bottom surface 276A of the recessed part 276. The amplification circuit element 244 is electrically connected to the wiring pattern 262 through a wire 289. Also, the amplification circuit element 244 is electrically connected to the wiring pattern 263 through a wire 291. The amplification circuit element 244 is means for amplifying a detection signal (weak current) according to illuminance of light outputted at the time when the light receiving elements 242 receive light from the outside.

The changeover switch element 245 is disposed on the bottom surface 276A of the recessed part 276. The changeover switch element 245 is electrically connected to the wiring pattern 261 through a wire 286. Also, the changeover switch element 245 is electrically connected to the wiring pattern 262 through a wire 287. The changeover switch element 245 is means for performing switching as to whether or not the light receiving elements 242 are electrically connected to the amplification circuit element 244 (switching as to whether or not the detection signal detected by the light receiving elements 242 is sent to the amplification circuit element 244).

The translucent member 247 is fixed on the ceramic substrate body 251. The translucent member 247 is means for hermetically sealing space J formed by the recessed part 276 in a state capable of transmitting light applied from the outside.

The chip resistor 203 is disposed on the wiring substrate 201. The chip resistor 203 is electrically connected to the wiring 222 through an internal connection terminal 295 and also is electrically connected to the wiring 223 through an internal connection terminal 296. Also, the chip resistor 203 is electrically connected to the amplification circuit element 244.

The chip capacitor 204 is disposed on the wiring substrate 201. The chip capacitor 204 is electrically connected to the wiring 223 through an internal connection terminal 297 and also is electrically connected to the wiring 224 through an internal connection terminal 298. Also, the chip capacitor 204 is electrically connected to the amplification circuit element 244. The chip resistor 203 and the chip capacitor 204 are means for optimizing characteristics (for example, a gain) of the amplification circuit element 244 according to characteristics of the plural light receiving elements 242 (for example, see Patent Reference 1).

[Patent Reference 1] Japanese Patent Application Publication No. 2007-27279

However, the related-art illuminance detection apparatus 200 had a problem that the illuminance detection apparatus 200 becomes large since the chip resistor 203 and the chip capacitor 204 are disposed on a substrate (concretely, the wiring substrate 201) different from a substrate (concretely, the ceramic substrate 241) on which the plural light receiving elements 242, the amplification circuit element 244 and the changeover switch element 245 are disposed.

Also, there was a similar problem in a sensor module in which the related-art illuminance detection apparatus 200 is mounted on another wiring substrate.

### SUMMARY

Exemplary embodiments of the present invention provide an illuminance detection apparatus and a sensor module capable of achieving miniaturization.

According to one standpoint of the invention, there is provided an illuminance detection apparatus comprising a wiring substrate having a substrate body, a pad and a wiring pattern disposed on a principal surface of the substrate body, and a through via which extends through the substrate body and also is electrically connected to the pad or the wiring pattern, plural light receiving elements which are disposed in the wiring substrate and output a detection signal according to illuminance of light applied from the outside, an amplification circuit element which is disposed in the wiring substrate and amplifies the detection signal, and a changeover switch element which is disposed in the wiring substrate and performs switching as to whether or not the light receiving element is electrically connected to the amplification circuit element, wherein a silicon substrate is used as the substrate body and also a passive element electrically connected to the amplification circuit element is disposed in the wiring substrate.

According to the invention, by disposing the passive element electrically connected to the amplification circuit element in the wiring substrate, the illuminance detection apparatus can be miniaturized as compared with the case of disposing the passive element in a different substrate. Also, warpage of the wiring substrate can be reduced by using the silicon substrate with warpage less than that of a ceramic plate as the substrate body, so that reliability of a detection signal of the light receiving element can be improved.

Also, a capacitor and/or a resistor may be used as the passive element. Consequently, characteristics (for example, again) of the amplification circuit element can be optimized according to characteristics of the plural light receiving elements.

Also, a thin film formed by a thin film formation technique maybe used as the passive element. Consequently, cost of the passive element can be reduced as compared with the case of using a chip component as the passive element, so that cost of the illuminance detection apparatus can be reduced.

Also, a translucent member having a recessed part for accommodating the plural light receiving elements, the amplification circuit element, the changeover switch element and the passive element may be disposed on the principal surface of the substrate body. Consequently, space formed by the recessed part is hermetically sealed, so that dust or a foreign substance can be prevented from adhering to the light receiving elements.

Also, a glass substrate may be used as the translucent member and also the glass substrate may be anodically bonded to the silicon substrate. Consequently, the space formed by the recessed part can be prevented from being contaminated.

Also, an antireflective film for preventing light applied from the outside from being reflected in a surface of the translucent member may be disposed on a surface of the translucent member positioned in the side opposite to the side in which the recessed part is formed. Consequently, illuminance according to the actually applied light can be detected.

Also, an external connection terminal electrically connected to the through via may be disposed on the wiring substrate positioned in the side opposite to the principal surface of the substrate body. Consequently, a detection signal of the light receiving elements amplified by the amplification circuit element can be transmitted to the outside.

According to another standpoint of the invention, there is provided a sensor module characterized by comprising an illuminance detection apparatus as claimed in any one of claims 1-8, and a wiring substrate for wireless for sending the detection signal according to illuminance of light outputted from the illuminance detection apparatus to the outside by wireless.

According to the invention, the sensor module can be miniaturized by comprising the illuminance detection apparatus as claimed in any one of claims 1-8. Also, by comprising the wiring substrate for wireless for sending a detection signal according to illuminance of light outputted from the illuminance detection apparatus to the outside by wireless, detection of the illuminance and sending of the detected signal can be performed by one module.

According to the invention, miniaturization of an illuminance detection apparatus and a sensor module can be achieved.

Other features and advantages may be apparent from the following detailed description, the accompanying drawings and the claims.

### BRIEF DESCRIPTION OF THE DRAWINGS

FIG. 1 is a sectional view of a related-art illuminance detection apparatus.

FIG. 2 is a plan view of an illuminance detection apparatus according to an embodiment of the invention.

FIG. 3 is a sectional view of a direction of line A-A of the illuminance detection apparatus shown in FIG. 2.

FIG. 4 is a sectional view of a direction of line B-B of the illuminance detection apparatus shown in FIG. 2.

FIG. 5 is a sectional view of a sensor module comprising the illuminance detection apparatus of the present invention.

FIG. 6 is a sectional view of an illuminance detection apparatus according to a modified embodiment of the invention.

### DETAILED DESCRIPTION

Next, embodiments of the invention will be described based on the drawings.

### Embodiment

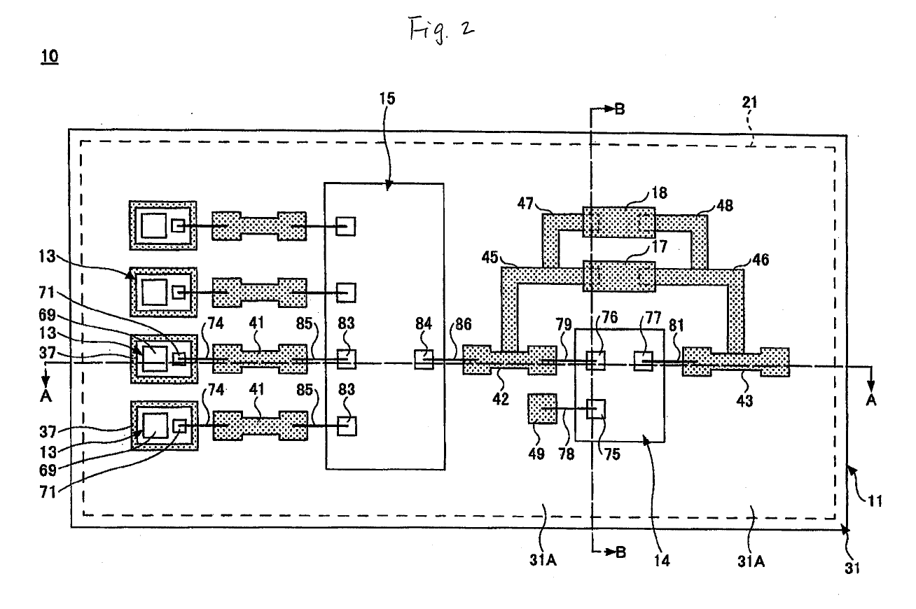

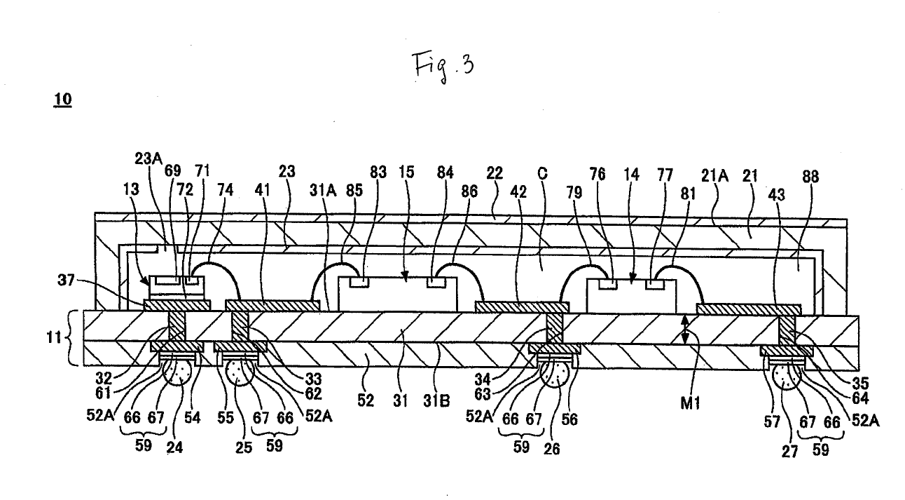

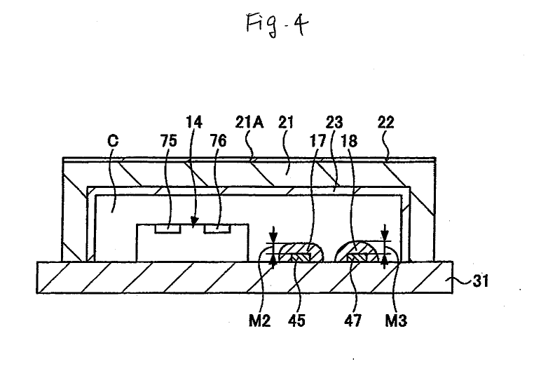

FIG. 2 is a plan view of an illuminance detection apparatus according to an embodiment of the invention, and FIG. 3 is a sectional view of a direction of line A-A of the illuminance detection apparatus shown in FIG. 2, and FIG. 4 is a sectional view of a direction of line B-B of the illuminance detection apparatus shown in FIG. 2. In addition, in FIG. 2, a translucent member 21 is shown by a chain line and also illustration of an antireflective film 22 is omitted.

Referring to FIGS. 2 to 4, an illuminance detection apparatus 10 of the present embodiment has a wiring substrate 11, plural light receiving elements 13, an amplification circuit element 14, a changeover switch element 15, a resistor 17 and a capacitor 18 which are passive elements, the translucent member 21, the antireflective film 22, a light blocking member 23, and external connection terminals 24 to 27.

The wiring substrate 11 has a substrate body 31, through vias 32 to 35, pads 37 for light receiving element placement, wiring patterns 41 to 43, 45 to 48, a pad 49, a solder resist 52, pads 54 to 57 for external connection, and diffusion preventive films 59.

The substrate body 31 is a silicon substrate in which through holes 61 to 64 are formed. By using the silicon substrate as the substrate body 31 thus, warpage of the wiring substrate 11 can be reduced as compared with the case of using a ceramic plate, so that reliability of a detection signal (weak current) outputted at the time when the plural light receiving elements 13 disposed on the wiring substrate 11 receive light can be improved. A thickness M1 of the substrate body 31 can be set at, for example, 200 μm.

The through vias 32 to 35 are disposed in the through holes 61 to 64. As material of the through vias 32 to 35, for example, Cu can be used. The through vias 32 to 35 can be formed by, for example, a plating method.

The pads 37 for light receiving element placement are disposed at a predetermined spacing on an upper surface 31A of the substrate body 31 of the portion corresponding to a formation position of the through via 32. The pads 37 for light receiving element placement are connected to the upper end of the through via 32.

The wiring pattern 41 is disposed on the upper surface 31A of the substrate body 31 positioned between the light receiving elements 13 and the changeover switch element 15. The wiring pattern 41 is connected to the upper end of the through via 33. The wiring pattern 42 is disposed on the upper surface 31A of the substrate body 31 positioned between the amplification circuit element 14 and the changeover switch element 15. The wiring pattern 42 is connected to the upper end of the through via 34. The wiring pattern 43 is disposed on the upper surface 31A of the substrate body 31 positioned in the vicinity of the amplification circuit element 14. The wiring pattern 43 is connected to the upper end of the through via 35.

The wiring patterns 45 to 48 are disposed on the upper surface 31A of the substrate body 31 positioned in the vicinity of the amplification circuit element 14. One end of the wiring pattern 45 is connected to the wiring pattern 42 and the other end is connected to the resistor 17. One end of the wiring pattern 46 is connected to the wiring pattern 43 and the other end is connected to the resistor 17. One end of the wiring pattern 47 is connected to the wiring pattern 45 and the other end is connected to the capacitor 18. One end of the wiring pattern 48 is connected to the wiring pattern 46 and the other end is connected to the capacitor 18.

The pad 49 is disposed on the upper surface 31A of the substrate body 31 positioned in the vicinity of the amplification circuit element 14. The pad 49 is electrically connected to a ground layer (not shown). Consequently, the pad 49 is set at a ground potential.

The solder resist 52 is disposed on a lower surface 31B of the substrate body 31. The solder resist 52 has opening parts 52A for exposing the pads 54 to 57 for external connection of the portions corresponding to formation positions of the diffusion preventive films 59.

The pads 54 to 57 for external connection are disposed on the lower surface 31B of the substrate body 31. The pad 54 for external connection is connected to the lower end of the through via 32. The pad 54 for external connection is electrically connected to the pads 37 for light receiving element placement through the through via 32. The pad 55 for external connection is connected to the lower end of the through via 33. The pad 55 for external connection is electrically connected to the wiring pattern 41 through the through via 33. The pad 56 for external connection is connected to the lower end of the through via 34. The pad 56 for external connection is electrically connected to the wiring pattern 42 through the through via 34. The pad 57 for external connection is connected to the lower end of the through via 35. The pad 57 for external connection is electrically connected to the wiring pattern 43 through the through via 35.

The diffusion preventive films 59 are disposed on the pads 54 to 57 for external connection of the portions corresponding to formation positions of the opening parts 52A. The diffusion preventive films 59 are films for preventing Cu included in the pads 54 to 57 for external connection from diffusing to the external connection terminals 24 to 27. The diffusion preventive films 59 are constructed of Ni layers 66 disposed on the pads 54 to 57 for external connection and Au layers 67 disposed on the Ni layers 66. A thickness of the Ni layer 66 can be set at, for example, 3 μm. Also, a thickness of the Au layer 67 can be set at, for example, 1.5 μm.

The light receiving element 13 has a light receiving part 69 for receiving light applied from the outside, a positive electrode 71 and a negative electrode 72. The light receiving elements 13 are disposed on the plural pads 37 for light receiving element placement so as to electrically connect the negative electrodes 72 to the pads 37 for light receiving element placement. The light receiving part 69 and the positive electrode 71 are opposed to the translucent member 21. The positive electrode 71 is connected to a metal wire 74 and also is electrically connected to the wiring pattern 41 through the metal wire 74. The light receiving element 13 is an element for outputting a detection signal (weak current) according to illuminance of light applied at the time of receiving the light applied from the outside. As the light receiving element 13, for example, a photodiode can be used.

The amplification circuit element 14 has electrode pads 75 to 77. The amplification circuit element 14 is fixed on the upper surface 31A of the substrate body 31 so as to oppose the electrode pads 75 to 77 to the translucent member 21. The electrode pad 75 is connected to a metal wire 78 and also is electrically connected to the pad 49 through the metal wire 78. The electrode pad 76 is connected to a metal wire 79 and also is electrically connected to the wiring pattern 42 through the metal wire 79. The electrode pad 77 is connected to a metal wire 81 and also is electrically connected to the wiring pattern 43 through the metal wire 81. The amplification circuit element 14 is -means for receiving a detection signal (weak current) of the light receiving element 13 sent through the changeover switch element 15 and also amplifying the detection signal.

The changeover switch element 15 has plural electrode pads 83 and an electrode pad 84. The changeover switch element 15 is fixed on the upper surface 31A of the substrate body 31 positioned between the plural light receiving elements 13 and the amplification circuit element 14 so as to oppose the electrode pads 83, 84 to the translucent member 21. Each of the electrode pads 83 is connected to a metal wire 85 and also is electrically connected to the wiring pattern 41 through the metal wire 85. The electrode pad 84 is connected to a metal wire 86 and also is electrically connected to the wiring pattern 42 through the metal wire 86. The changeover switch element 15 is means for performing switching as to which light receiving element 13 of the plural light receiving elements 13 is electrically connected to the amplification circuit element 14 (switching as to whether or not a detection signal detected by the light receiving elements 13 is sent to the amplification circuit element 14).

The resistor 17 is disposed on the wiring substrate 11 so as to extend from the other end of the wiring pattern 45 to the other end of the wiring pattern 46. The resistor 17 is electrically connected to the amplification circuit element 14 through the wiring patterns 45, 46. The resistor 17 is means for optimizing characteristics (for example, a gain) of the amplification circuit element 14 according to variations in characteristics of the plural light receiving elements 13.

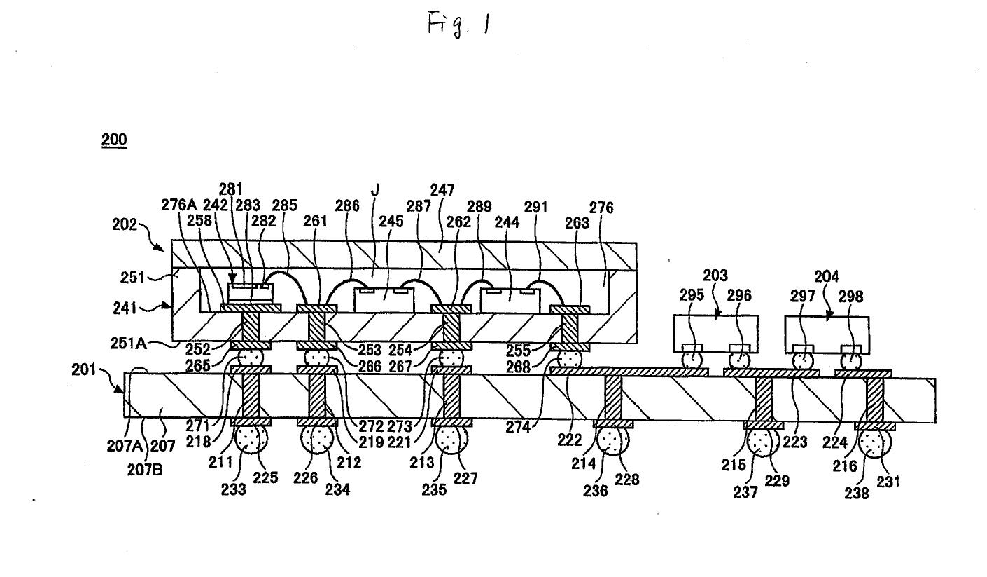

By disposing the resistor 17 on the wiring substrate 11 in which the plural light receiving elements 13, the amplification circuit element 14 and the changeover switch element 15 are disposed thus, the illuminance detection apparatus 10 can be miniaturized as compared with the related-art illuminance detection apparatus 200 (see FIG. 1) in which the chip resistor 203 is disposed on a substrate (concretely, the wiring substrate 201) different from a substrate (concretely, the ceramic substrate 241) on which the light receiving elements 242, the amplification circuit element 244 and the changeover switch element 245 are disposed.

As the resistor 17, for example, a thin film formed by a thin film formation technique (for example, a sputtering method or a vapor deposition method) could be used (the thin film formation technique can be applied since the substrate body 31 is a silicon substrate). As the resistor 17, for example, a Ta₂N film can be used. When the Ta₂N film is used as the resistor 17, a thickness M2 of the resistor 17 can be set at, for example, 0.1 μm to 1 μm.

By using the thin film formed by the thin film formation technique (for example, the sputtering method or the vapor deposition method) as the resistor 17 thus, cost of the resistor 17 can be reduced, so that cost of the illuminance detection apparatus 10 can be reduced.

The capacitor 18 is disposed on the wiring substrate 11 so as to extend from the other end of the wiring pattern 47 to the other end of the wiring pattern 48. The capacitor 18 is electrically connected to the amplification circuit element 14 through the wiring patterns 47, 48. The capacitor 18 is means for optimizing characteristics (for example, a gain) of the amplification circuit element 14 according to variations in characteristics of the plural light receiving elements 13.

By disposing the capacitor 18 on the wiring substrate 11 in which the plural light receiving elements 13, the amplification circuit element 14 and the changeover switch element 15 are disposed thus, the illuminance detection apparatus 10 can be miniaturized as compared with the related-art illuminance detection apparatus 200 (see FIG. 1) in which the chip capacitor 204 is disposed on a substrate (concretely, the wiring substrate 201) different from a substrate (concretely, the ceramic substrate 241) on which the light receiving elements 242, the amplification circuit element 244 and the changeover switch element 245 are disposed.

As the capacitor 18, for example, a thin film formed by a thin film formation technique (for example, a sputtering method or a vapor deposition method) could be used (the thin film formation technique can be applied since the substrate body 31 is a silicon substrate). As the capacitor 18, for example, a Ta₂O₅ film can be used as a dielectric. When the Ta₂O₅ film is used as the capacitor 18, a thickness M3 of the capacitor 18 can be set at, for example, 0.2 μm to 1 μm.

By using the thin film formed by the thin film formation technique (for example, the sputtering method or the vapor deposition method) as the capacitor 18 thus, cost of the capacitor 18 can be reduced, so that cost of the illuminance detection apparatus 10 can be reduced.

The translucent member 21 has a recessed part 88 for accommodating the plural light receiving elements 13, the amplification circuit element 14, the changeover switch element 15, the resistor 17 and the capacitor 18. The translucent member 21 is bonded to the upper surface 31A of the substrate body 31 so as to oppose the recessed part 88 to the wiring substrate 11. The translucent member 21 is means for hermetically sealing space C formed by the recessed part 88 in a state capable of transmitting light applied from the outside.

By disposing such a translucent member 21, the space C formed by the recessed part 88 is hermetically sealed, so that dust or a foreign substance can be prevented from adhering to the light receiving parts 69 of the plural light receiving elements 13.

As the translucent member 21, for example, a glass substrate can be used. When the glass substrate is used as the translucent member 21, the translucent member 21 could be anodically bonded to the substrate body 31 (silicon substrate). By anodically bonding the translucent member 21 (glass substrate) to the substrate body 31 (silicon substrate) thus, the space C formed by the recessed part 88 can be prevented from being contaminated.

The antireflective film 22 is disposed so as to cover a surface 21A of the translucent member 21 of the side to which light is applied from the outside. The antireflective film 22 is means for preventing the light applied from the outside from being reflected in the surface 21A of the translucent member 21. As the antireflective film 22, for example, a Ta₂O₅/SiO₂ stacked film in which a Ta₂O₅ film and an SiO₂ film are sequentially stacked on the surface 21A of the translucent member 21 can be used. The Ta₂O₅/SiO₂ stacked film can be formed by a method such as a sputtering method or a vapor deposition method. A thickness of the Ta₂O₅ film can be set at, for example, 0.2 Å. Also, a thickness of the SiO₂ film can be set at, for example, 0.13 Å.

By disposing the antireflective film 22 on the surface 21A of the translucent member 21 thus, illuminance according to the light actually applied from the outside can be detected.

The light blocking member 23 has an opening part 23A for exposing the translucent member 21 in the portion opposed to the light receiving parts 69 of the light receiving elements 13. The opening part 23A is means for transmitting light applied from the outside to the light receiving parts 69 of the light receiving elements 13.

By disposing the light blocking member 23 having the opening part 23A in the portion opposed to the light receiving parts 69 of the light receiving elements 13 so as to cover a surface of the translucent member 21 of the portion corresponding to the recessed part 88 thus, the plural light receiving elements 13 can detect only illuminance of light applied to an arrangement position of each of the light receiving elements 13, so that illuminance of the light with a narrow range can be detected.

Also, a diameter of the opening part 23A could be made smaller than a diameter of an effective area (not shown) of the light receiving parts 69 of the light receiving elements 13. Consequently, application of light to an area other than the effective area of the light receiving parts 69 is eliminated, so that reliability of illuminance of light detected by the plural light receiving elements 13 can be improved. When the diameter of the effective area is φ0.8 mm, the diameter of the opening part 23A can be set at, for example, φ0.4 mm.

As the light blocking member 23 configured as described above, for example, a silicon film can be used. In this case, a thickness of the silicon film can be set at, for example, 5 Å. Also, the silicon film can be formed by, for example, a vapor deposition method.

The external connection terminal 24 is disposed on the diffusion preventive film 59 formed on the pad 54 for external connection and is electrically connected to the through via 32. The external connection terminal 25 is disposed on the diffusion preventive film 59 formed on the pad 55 for external connection and is electrically connected to the through via 33. The external connection terminal 26 is disposed on the diffusion preventive film 59 formed on the pad 56 for external connection and is electrically connected to the through via 34. The external connection terminal 27 is disposed on the diffusion preventive film 59 formed on the pad 57 for external connection. The external connection terminal 27 is electrically connected to the through via 35.

By disposing such external connection terminals 24 to 27 on the wiring substrate 11, a detection signal of the light receiving elements 13 amplified by the amplification circuit element 14 can be transmitted to the outside.

According to the illuminance detection apparatus of the embodiment, by disposing the resistor 17 and the capacitor 18 on the wiring substrate 11 in which the plural light receiving elements 13, the amplification circuit element 14 and the changeover switch element 15 are disposed, the illuminance detection apparatus 10 can be miniaturized as compared with the related-art illuminance detection apparatus 200 (see FIG. 1) in which the chip resistor 203 and the chip capacitor 204 are disposed on a substrate (concretely, the wiring substrate 201) different from a substrate (concretely, the ceramic substrate 241) on which the light receiving elements 242, the amplification circuit element 244 and the changeover switch element 245 are disposed.

Also, by using a silicon substrate as the substrate body 31, as compared with the case of using a ceramic plate as the substrate body 31, warpage of the wiring substrate 11 can be reduced and accuracy of a mounting position of the light receiving elements 13 can be improved, so that reliability of a detection signal outputted by the light receiving elements 13 can be improved.

In addition, in the embodiment, the case of arranging the plural light receiving elements 13 in one line has been described as the example, but the plural light receiving elements 13 may be arranged on the wiring substrate 11 in an array shape.

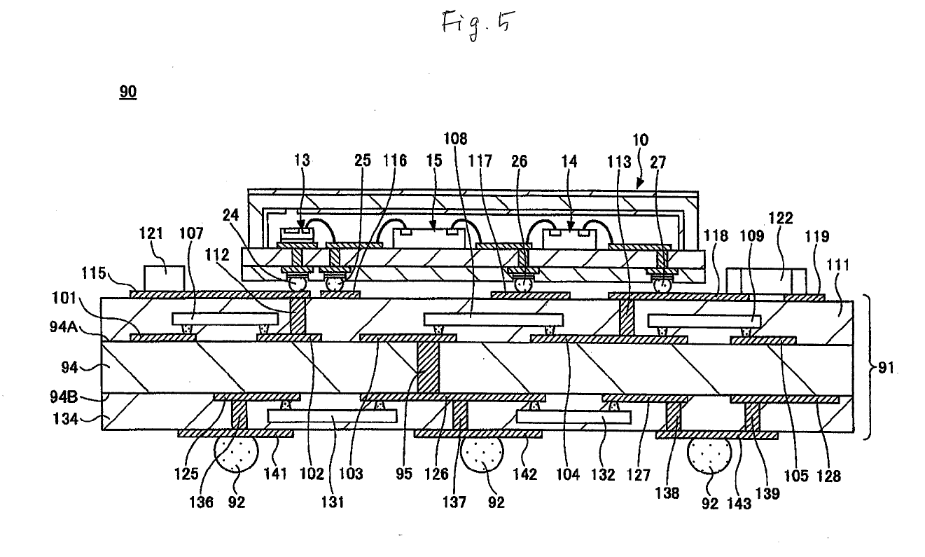

FIG. 5 is a sectional view of a sensor module comprising the illuminance detection apparatus of the present invention.

Next, a sensor module 90 comprising the illuminance detection apparatus 10 will be described with reference to FIG. 5. The sensor module 90 has the illuminance detection apparatus 10, a wiring substrate 91 for wireless in which the illuminance detection apparatus 10 is mounted, and external connection terminals 92.

The wiring substrate 91 for wireless has a substrate body 94, a through via 95, wirings 101 to 105, 115 to 119, 125 to 127, 141, 142, EEPROM 107, a CPU 108, an ADC (Analog to Digital Converter) 109, insulating layers 111, 134, vias 112, 113, 136 to 139, a chip capacitor 121, a chip resistor 122, an antenna 128, a CPU 131 for wireless, an RFIC 132 for wireless, and a balun 143.

The substrate body 94 is a core substrate. The through via 95 is disposed so as to extend through the substrate body 94. The wirings 101 to 105 are disposed on an upper surface 94A of the substrate body 94. The EEPROM 107 is connected to the wirings 101, 102. The EEPROM 107 is means for temporarily keeping a detection signal according to illuminance of light outputted from the illuminance detection apparatus 10 as data.

The CPU 108 is connected to the wirings 103, 104. The CPU 108 is means for creating illuminance detection data based on a digital signal sent from the ADC 109. The ADC 109 is connected to the wirings 104, 105. The ADC 109 is means for converting a detection signal (analog signal) according to illuminance of light outputted from the illuminance detection apparatus 10 into a digital signal.

The insulating layer 111 is disposed on the upper surface 94A of the substrate body 94 so as to cover the wirings 101 to 105, the EEPROM 107, the CPU 108 and the ADC 109.

The via 112 is formed so as to extend through the insulating layer 111 and the lower end is connected to the wiring 102. The via 113 is formed so as to extend through the insulating layer 111 and the lower end is connected to the wiring 104.

The wirings 115 to 119 are disposed on the insulating layer 111. The wiring 115 is connected to the upper end of the via 112 and the external connection terminal 24 of the illuminance detection apparatus 10. The wiring 116 is connected to the external connection terminal 25 of the illuminance detection apparatus 10. The wiring 117 is connected to the external connection terminal 26 of the illuminance detection apparatus 10. The wiring 118 is connected to the upper end of the via 113 and the external connection terminal 27 of the illuminance detection apparatus 10.

The chip capacitor 121 is mounted on the wiring 115. The chip capacitor 121 is electrically connected to the wiring 115. The chip resistor 122 is mounted on the wirings 118, 119. The chip resistor 122 is electrically connected to the wirings 118, 119. The wirings 125 to 127 are disposed on a lower surface 94B of the substrate body 94. The wiring 126 is connected to the lower end of the through via 95. The antenna 128 is means simultaneously incorporated at the time of forming the wiring and is disposed on the lower surface 94B of the substrate body 94.

The CPU 131 for wireless is connected to the wirings 125, 126. The RFIC 132 for wireless is connected to the wirings 126, 127. The CPU 131 for wireless and the RFIC 132 for wireless are means for creating and converting data for wireless output.

The insulating layer 134 is disposed on the lower surface 94B of the substrate body 94 so as to cover the wirings 125 to 127, the antenna 128, the CPU 131 for wireless and the RFIC 132 for wireless.

The via 136 is formed so as to extend through the insulating layer 134 and the upper end is connected to the wiring 125. The via 137 is formed so as to extend through the insulating layer 134 and the upper end is connected to the wiring 126. The via 138 is formed so as to extend through the insulating layer 134 and the upper end is connected to the wiring 127. The via 139 is formed so as to extend through the insulating layer 134 and the upper end is connected to the antenna 128.

The wirings 141, 142 are disposed on a lower surface of the insulating layer 134. The wiring 141 is connected to the lower end of the via 136. The wiring 142 is connected to the lower end of the via 137. The balun 143 is connected to the lower ends of the vias 138, 139. The balun 143 is electrically connected to the antenna 128 through the via 139.

The wiring substrate 91 for wireless configured as described above is means for sending a detection signal according to illuminance of light outputted from the illuminance detection apparatus 10 to the outside by wireless.

According to the sensor module of the embodiment, the sensor module can be miniaturized by comprising the illuminance detection apparatus 10. Also, by comprising the wiring substrate 91 for wireless for sending a detection signal according to illuminance of light outputted from the illuminance detection apparatus to the outside by wireless, detection of the illuminance and sending of the detected signal can be performed by one module.

The preferred embodiment of the invention has been described above in detail, but the invention is not limited to such a specific embodiment, and various modifications and changes can be made within the gist of the invention described in the claims.

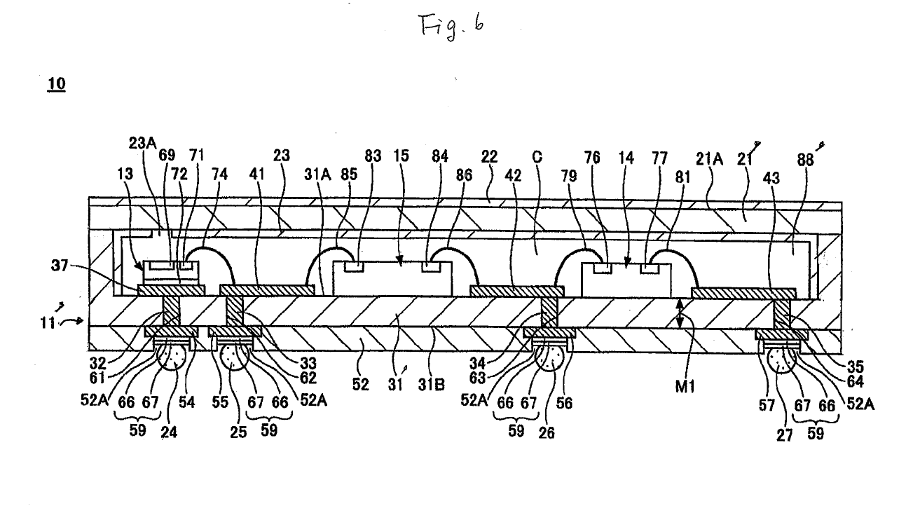

For example, in the above described embodiment, the substrate body 31 of the wiring substrate 11 is shaped like a flat plate, and the recess part 88 for accommodating the light receiving elements 13, the amplification circuit element 14, the changeover switch element 15, the resistor 17 and the capacitor 18 is formed in the translucent member 21. However, the recess part constituting the space C is not always provided to the translucent member 21, and may be formed on the substrate body 31 of the wiring substrate 11. More specifically, as shown in FIG. 6, a recess part 88′ may be formed in a substrate body 31′ of a wiring substrate 11′ and a translucent member 21′ may be shaped into a flat plate.

The invention can be applied to an illuminance detection apparatus for detecting illuminance of light applied from the outside, and a sensor module.

What is claimed is:

1. An illuminance detection apparatus comprising:
a wiring substrate having a substrate body which is made of silicon, a pad and a wiring pattern which are disposed on a principal surface of the substrate body, and a through via which extends through the substrate body and also is electrically connected to the pad or the wiring pattern;
a plurality of light receiving elements which are disposed in the wiring substrate and output a detection signal according to illuminance of light applied from the outside;
an amplification circuit element which is disposed in the wiring substrate and amplifies the detection signal;
a changeover switch element which is disposed in the wiring substrate and performs switching as to whether or not the light receiving element is electrically connected to the amplification circuit element; and
a passive element which is electrically connected to the amplification circuit element and is disposed in the wiring substrate.

2. An illuminance detection apparatus as claimed in claim 1, wherein the passive element is at least one of a capacitor or a resistor.

3. An illuminance detection apparatus as claimed in claim 1, wherein the passive element is a thin film formed by a thin film formation technique.

4. An illuminance detection apparatus as claimed in claim 1, further comprising:
a translucent member which has a recessed part for accommodating the plurality of light receiving elements, the amplification circuit element, the changeover switch element and the passive element and is disposed on the principal surface of the substrate body.

5. An illuminance detection apparatus as claimed in claim 1, wherein the translucent member is a glass substrate, and the glass substrate is anodically bonded to the substrate body.

6. An illuminance detection apparatus as claimed in claim 4, further comprising:
an antireflective film which is disposed on a surface of the translucent member positioned in the side opposite to the side in which the recessed part is formed and prevents light applied from the outside from being reflected in the surface of the translucent member.

7. An illuminance detection apparatus as claimed in claim 1, further comprising:
an external connection terminal which is electrically connected to the through via and is disposed on the wiring substrate positioned in the side opposite to the principal surface of the substrate body.

8. An illuminance detection apparatus as claimed in claim 4, wherein the plurality of light receiving elements have light receiving parts for receiving light applied from the outside, and said illuminance detection apparatus further comprises:
a light blocking member which is disposed in the translucent member of a portion corresponding to the recessed part and blocks the light applied from the outside, the light blocking member having an opening part which is disposed in the light blocking member of a portion opposed to the light receiving parts of the plurality of light receiving elements and transmits the light applied from the outside.

9. An illuminance detection apparatus as claimed in claim 1, wherein the substrate body has a recessed part for accommodating the plurality of light receiving elements, the amplification circuit element, the changeover switch element and the passive element.

10. A sensor module comprising:
an illuminance detection apparatus as claimed in claim 1; and
a wiring substrate for wireless for sending the detection signal according to illuminance of light outputted from the illuminance detection apparatus to the outside by wireless.
